(19) United States
(12) Patent Application Publication
(10) Pub. No.: US 2026/0333498 A1
(43) Pub. Date: Oct. 22, 2026

(54) DIFFERENT OPERATING MODE, PARAMETERS, CAPABILITIES, AND PHYSICAL GENERATION SUPPORT IN A MULTIPLE BASIC SERVICE SET IDENTIFIER SET

(71) Applicant: Cisco Technology, Inc., San Jose, CA (US)

(72) Inventors: Binita Gupta, San Diego, CA (US); Brian D. Hart, Sunnyvale, CA (US)

(73) Assignee: Cisco Technology, Inc., San Jose, CA (US)

(21) Appl. No.: 19/649,805

(22) Filed: Apr. 16, 2026

Related U.S. Application Data
(60) Provisional application No. 63/789,801, filed on Apr. 16, 2025.
(60) Provisional application No. 63/813,338, filed on May 28, 2025.

(51) Int. Cl. H04W 76/20; H04W 8/22; H04W 84/12

(52) U.S. Cl. CPC H04W 76/20; H04W 8/22; H04W 84/12

(57) ABSTRACT

Different operating modes, parameters, capabilities, and PHY generation support in a multiple Basic Service Set Identifier (BSSID) set may be provided. An access point (AP) corresponding to a transmitted BSSID of a multiple BSSID set generates a management frame comprising a multiple BSSID element, the multiple BSSID element comprising one or more nontransmitted BSSID profile subelements each corresponding to a respective nontransmitted BSSID of the multiple BSSID set, wherein at least one nontransmitted BSSID profile subelement of the one or more nontransmitted BSSID profile subelements comprises an operation element indicating at least one of: (i) one or more operating modes enabled for a corresponding nontransmitted BSSID, or (ii) one or more operating mode parameters for the corresponding nontransmitted BSSID. The AP corresponding to the transmitted BSSID transmits the management frame.

### RELATED APPLICATIONS

Under provisions of 35 U.S.C. § 119(e), Applicant claims the benefit of and priority to U.S. Provisional Application No. 63/789,801, filed Apr. 16, 2025, and U.S. Provisional Application No. 63/813,338, filed May 28, 2025, the disclosures of which are incorporated herein by reference in their entirety.

### TECHNICAL FIELD

The present disclosure relates generally to providing different operating modes, parameters, and generational capabilities support in a multiple Basic Service Set Identifier (BSSID) set.

### BACKGROUND

In computer networking, a wireless Access Point (AP) is a networking hardware device that allows a Wi-Fi compatible client device to connect to a wired network and to other client devices. The AP usually connects to a router (directly or indirectly via a wired network) as a standalone device, but it can also be an integral component of the router itself. Several APs may also work in coordination, either through direct wired or wireless connections, or through a central system, commonly called a Wireless Local Area Network (WLAN) controller. An AP is differentiated from a hotspot, which is the physical location where Wi-Fi access to a WLAN is available.

Prior to wireless networks, setting up a computer network in a business, home, or school often required running many cables through walls and ceilings in order to deliver network access to all of the network-enabled devices in the building. With the creation of the wireless AP, network users are able to add devices that access the network with few or no cables. An AP connects to a wired network, then provides radio frequency links for other radio devices to reach that wired network. Most APs support the connection of multiple wireless devices. APs are built to support a standard for sending and receiving data using these radio frequencies.

### BRIEF DESCRIPTION OF THE FIGURES

The accompanying drawings, which are incorporated in and constitute a part of this disclosure, illustrate various embodiments of the present disclosure. In the drawings:

FIG. 1 is a block diagram of an operating environment for providing different operating modes, parameters, capabilities, and Physical (PHY) generation support in a multiple Basic Service Set Identifier (BSSID) set in accordance with aspects of the present disclosure.

FIG. 2 illustrates an example AP device in accordance with aspects of the present disclosure.

FIG. 3 illustrates an example multiple BSSID element in accordance with aspects of the present disclosure.

FIG. 4 is a flow diagram illustrating a method for providing different operating modes, parameters, capabilities, and PHY generation support in a multiple BSSID set in accordance with aspects of the present disclosure.

FIG. 5 is a flow diagram illustrating another method for providing different operating modes, parameters, capabilities, and PHY generation support in a multiple BSSID set in accordance with aspects of the present disclosure.

FIG. 6 is a block diagram of a computing device in accordance with aspects of the present disclosure.

FIG. 7 is a block diagram of a communications device in accordance with aspects of the present disclosure.

### DETAILED DESCRIPTION

### Overview

Different operating modes, parameters, capabilities, and Physical (PHY) generation support in a multiple Basic Service Set Identifier (BSSID) set may be provided. An access point (AP) corresponding to a transmitted BSSID of a multiple BSSID set generates a management frame comprising a multiple BSSID element, the multiple BSSID element comprising one or more nontransmitted BSSID profile subelements each corresponding to a respective nontransmitted BSSID of the multiple BSSID set, wherein at least one nontransmitted BSSID profile subelement of the one or more nontransmitted BSSID profile subelements comprises an operation element indicating at least one of: (i) one or more operating modes enabled for a corresponding nontransmitted BSSID, or (ii) one or more operating mode parameters for the corresponding nontransmitted BSSID. The AP corresponding to the transmitted BSSID transmits the management frame.

Both the foregoing overview and the following example embodiments are examples and explanatory only and should not be considered to restrict the disclosure's scope, as described, and claimed. Furthermore, features and/or variations may be provided in addition to those described. For example, embodiments of the disclosure may be directed to various feature combinations and sub-combinations described in the example embodiments.

### Example Embodiments

The following detailed description refers to the accompanying drawings. Wherever possible, the same reference numbers are used in the drawings and the following description to refer to the same or similar elements. While embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims.

A multiple BSSID set is a Wi-Fi feature that allows a physical Access Point (AP) to advertise multiple Service Set Identifiers (SSIDs) within a single beacon frame or probe response frame, thereby reducing beacon overhead and improving airtime efficiency by consolidating information for co-located SSIDs/networks. A multiple BSSID set comprises a collection of BSSIDs for APs that operate on the same Radio Frequency channel on a physical AP, with one BSSID designated as the transmitted BSSID and the remaining BSSIDs designated as nontransmitted BSSIDs. The AP corresponding to the transmitted BSSID transmits a beacon frame on behalf of the entire set, and that beacon frame carries information for the nontransmitted BSSIDs as well. The BSSIDs in a multiple BSSID set may share a common operating class, channel, receive antenna connector, transmit antenna connector, and/or the like. This feature is used in deployments supporting separate SSIDs for corporate, guest, and IoT networks operating on a on a single channel on a physical AP device, and is mandatory in the 6 GHz band.

Information specific to the nontransmitted BSSIDs is carried in a Multiple BSSID element, such as in one or more nontransmitted BSSID profile subelements, within the beacon and probe response frames of the transmitted BSSID. Other information is inherited from the information of the transmitted BSSID. In existing implementations (and Institute of Electrical and Electronics Engineers (IEEE) baseline 802.11 standard), the operation parameters and capabilities of the all BSSIDs in a multiple BSSID set are assumed to be the same. As a result, Operation elements (e.g., High Efficiency (HE) Operation, Extremely High Throughput (EHT) Operation) and Capabilities elements (e.g., HE Capabilities, EHT Capabilities) are the same for transmitted and nontransmitted BSSIDs, and these elements are always considered inherited from the transmitted BSSID to the nontransmitted BSSIDs per the IEEE 802.11 specification. This universal inheritance of Operation and Capabilities elements reflects an underlying assumption that all BSSIDs in a multiple BSSID set share the same operation parameters, capabilities, and Physical (PHY) generation. While this assumption of inheritance simplified earlier designs, it results in limitations as Wi-Fi technology continues to evolve.

PHY generations refer to generations such as HE or Wi-Fi 6, EHT or Wi-Fi 7, and Ultra High Reliability (UHR) or Wi-Fi 8 and future Wi-Fi generations such as Wi-Fi 9. Support for a PHY generation is typically indicated by the AP by including the operation element and capabilities element corresponding to that generation in beacon, probe response, and (re)association response frames. For example, an AP indicates support for EHT by including an EHT Capabilities element and EHT Operation element in these frames. In a multiple BSSID set as defined currently in baseline 802.11 specification, if a transmitted BSSID supports EHT (Wi-Fi 7 generation), then the EHT Capabilities element and EHT Operation element from the transmitted BSSID is inherited for all the non-transmitted BSSIDs in that set.

For UHR and future Wi-Fi generations, several new operating modes are being defined, such as Non-Primary Channel Access (NPCA), Dynamic Subchannel Operation (DSO), Dynamic Bandwidth Expansion (DBE), and Prioritized Enhanced Distributed Channel Access (P-EDCA), and it is desirable for different BSSIDs within the same multiple BSSID set to have different sets of operating modes or features enabled, and potentially different parameters for those operating modes. For example, a network administrator may wish to enable a feature such as P-EDCA on an employee SSID but not on a guest SSID, due to the additional complexity or interference it may introduce for legacy Stations (STAs). Because Operation elements are currently inherited from the transmitted BSSID, the baseline mandates that all BSSIDs in the set support and enable exactly the same operating modes and use the same operating parameters, precluding per-BSSID level capability support and/or configuration of operating modes (or features) and associated operating parameters.

Additionally, the requirement that all BSSIDs in a multiple BSSID set support the same PHY generation constrains network operators in enterprise WLAN deployments. SSIDs are often upgraded at different points in time. For example, an operator may upgrade an employee SSID to Wi-Fi 9 while leaving a guest SSID at Wi-Fi 8. Because existing multiple BSSID sets can only contain BSSIDs of one generation, a mix of BSSIDs of different generations must be assigned to different multiple BSSID sets/groups, reducing the beacon-overhead efficiency gains that the multiple BSSID feature is designed to achieve. Furthermore, when a particular BSSID is reconfigured in the field to a different generation (e.g., from IEEE 802.11be (Wi-Fi 7) to IEEE 802.11bn (Wi-Fi 8)) the multiple BSSID grouping must change, and such a change causes disruption to other BSSIDs and their associated client STAs in the set.

Embodiments of the present disclosure address these limitations by defining mechanisms that enable BSSIDs within a multiple BSSID set to support different operating modes, operating parameters, capabilities and PHY generations—referred to herein as a “flexible MBSSID set.” In a first embodiment, each nontransmitted BSSID profile included in a Multiple BSSID element is permitted to carry its own UHR Operation element, enabling per-BSSID configuration of operating modes and parameters for nontransmitted BSSIDs independently of the transmitted BSSID. Each nontransmitted BSSID profile included in a Multiple BSSID element is also permitted to carry its own UHR Capabilities element, enabling per-BSSID support for UHR capabilities for nontransmitted BSSIDs independently of the transmitted BSSID. This flexibility is also applied for future PHY generations where e.g. for Wi-Fi 9 each nontransmitted BSSID profile included in a Multiple BSSID element is permitted to carry its own Operation and Capabilities elements for Wi-Fi 9.

Reference throughout this specification to “one embodiment,” “an embodiment,” or similar language means that a particular feature, structure, or characteristic described in connection with the embodiment is included in at least one embodiment of the present disclosure. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to”, unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise. Further, as used herein, reference to reading, writing, storing, buffering, and/or transferring data can include the entirety of the data, a portion of the data, a set of the data, and/or a subset of the data.

The terms “or,” “and/or,” “at least one of,” and “one or both of” as used herein are to be interpreted as inclusive or meaning any one or any combination. Therefore, “A, B, or C” or “A, B, and/or C” mean “any of the following: A; B; C; A and B; A and C; B and C; A, B, and C.” An exception to this definition will occur only when a combination of elements, functions, steps, or acts are in some way inherently mutually exclusive.

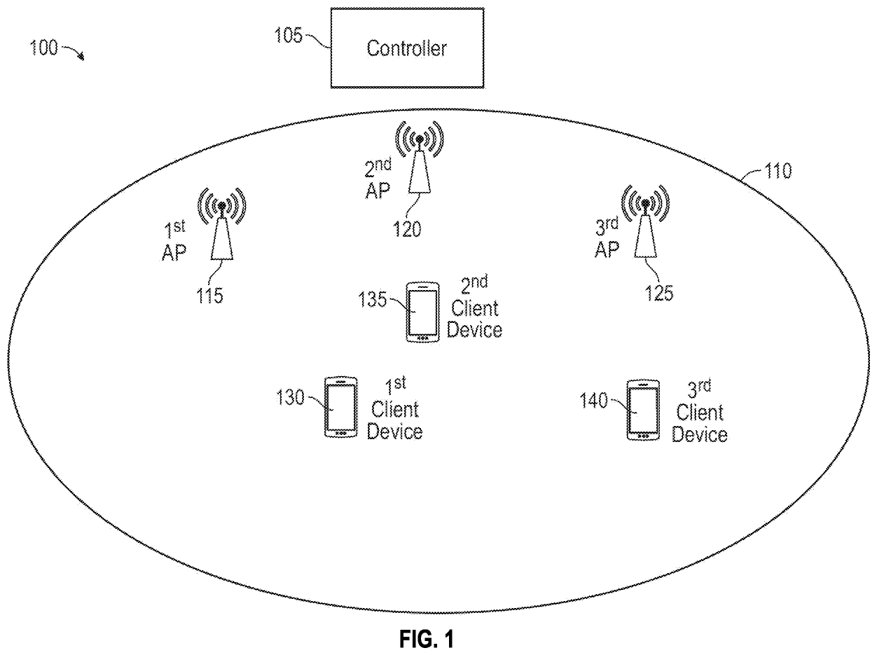

FIG. 1 illustrates an example operating environment 100 for enabling different operating modes, operation parameters, capabilities, and PHY generations for BSSIDs in a multiple BSSID set. As shown in FIG. 1, operating environment 100 comprises a controller 105 and a coverage environment 110. Coverage environment 110 comprises a Wireless Local Area Network (WLAN) comprising a plurality of physical APs that provide wireless network access for client devices. In the illustrated embodiment, the physical APs comprise a first AP 115, a second AP 120, and a third AP 125, though the plurality of APs may comprise any number of APs in further embodiments. Each physical AP may comprise one or more APs (e.g. virtual APs) that are hosted as collocated set of APs on the physical AP.

The APs provide wireless network access to client devices (i.e., STAs within coverage environment 110. The client devices comprise a first client device 130, a second client device 135, and a third client device 140. A client device may be any device capable of wirelessly connecting to the network, such as a smartphone, a personal computer, a tablet, a mobile device, a telephone, a remote control device, a set-top box, a digital video recorder, an Internet-of-Things (IoT) device, a network computer, a router, a Virtual Reality (VR)/Augmented Reality (AR) device, or other similar microcomputer-based device. The APs and client devices may be compatible with specification standards such as the IEEE 802.11 specification standard.

Each AP and its associated set of STAs may be referred to as a Basic Service Set (BSS), which is managed by the respective AP. A BSS may be identified to users by a SSID, and to other devices by a BSSID, which may be a Medium Access Control (MAC) address of the AP. The APs periodically broadcast beacon frames including the BSSID to enable STAs within wireless range of the respective AP to associate or reassociate with the AP in order to establish or maintain a link.

In certain embodiments, the APs and client devices may use Multi-Link Operation (MLO), under which they simultaneously transmit and receive across different bands or channels by establishing two or more links to two or more AP radios. These bands may include the 2.4 GHz band, the 5 GHz band, the 6 GHz band, and the 60 GHz band. The two or more links on any given client device may be established with a single AP or with any combination of the APs.

Each physical AP can include one or more APs (e.g., virtual APs) and one or more multiple BSSID sets comprising one or more APs that are collocated on the same physical AP. For example, an AP can maintain a multiple BSSID set of APs operating on the same channel, wherein one AP in the set corresponds to the transmitted BSSID and the remaining APs correspond to nontransmitted BSSIDs. Only the transmitted BSSID transmits beacon and probe response frames on behalf of the entire multiple BSSID set, carrying information for all nontransmitted BSSIDs in the set.

In accordance with the present disclosure, each physical AP in the operating environment 100 may transmit Multiple BSSID elements configured to enable each BSSID in a multiple BSSID set (also referred to herein as a flexible MBSSID set) to independently support different operating modes, operating mode parameters, capabilities, and/or PHY generations capabilities. This support includes (i) permitting nontransmitted BSSID profiles within a Multiple BSSID element to carry their own Operation element and/or Capabilities element, enabling per-BSSID configuration of operating modes, parameters, and capabilities independently of the transmitted BSSID, and (ii) permitting BSSIDs of different Wi-Fi generations (e.g., Wi-Fi 7 (IEEE 802.11be), Wi-Fi 8 (IEEE 802.11bn), and Wi-Fi 9) to coexist within the same multiple BSSID set, with each nontransmitted BSSID profile carrying the appropriate Operation elements and Capabilities elements for its respective generation or excluding the Operation elements and Capabilities elements from the transmitted BSSID that does not apply for its respective generation.

The controller 105 comprises a WLAN controller and may provision and control the coverage environment 110. The controller 105 may allow the first client device 130, the second client device 135, and the third client device 140 to join coverage environment 110. In some embodiments, the controller 105 may be implemented by a Digital Network Architecture Center (DNAC) controller (i.e., a Software-Defined Network (SDN) controller) that configures the APs to support flexible MBSSID sets as described herein. In some embodiments, controller 105 or another component of operating environment 100 may include a Radio Resource Management (RRM) function configured to optimize wireless performance across coverage environment 110.

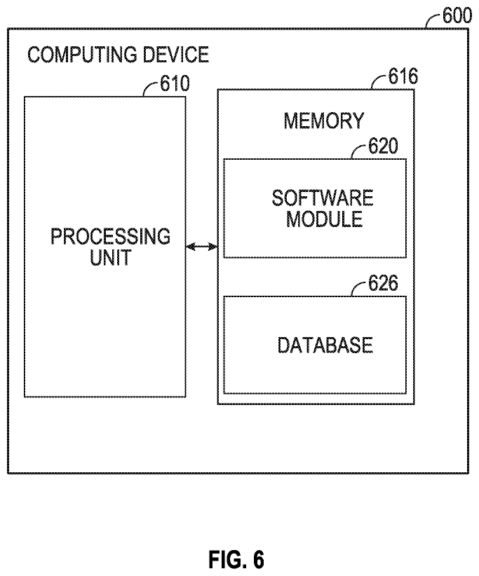

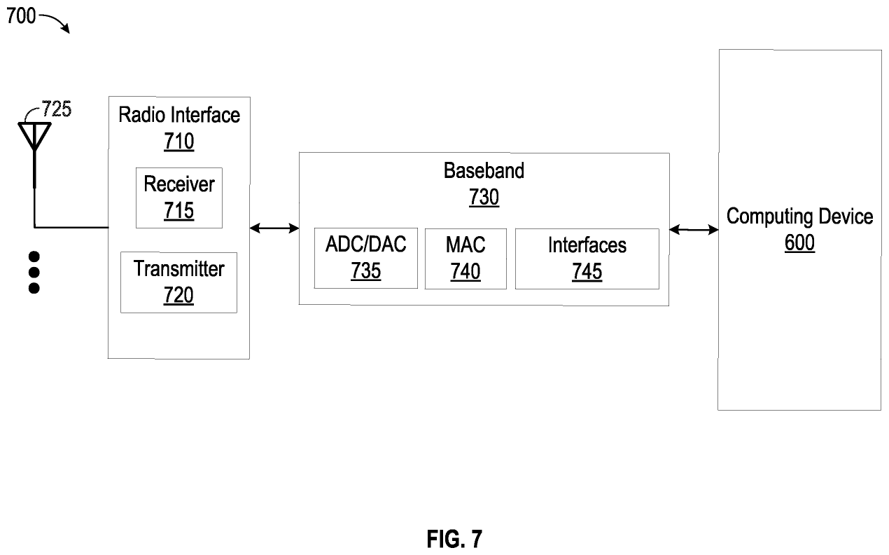

The elements described above of the operating environment 100 (e.g., the controller 105, the first AP 115, the second AP 120, the third AP 125, the first client device 130, the second client device 135, and the third client device 140, etc.) may be practiced in hardware, in software (including firmware, resident software, micro-code, etc.), in a combination of hardware and software, or in any other circuits or systems. The elements of the operating environment 100 may be practiced in electrical circuits comprising discrete electronic elements, packaged or integrated electronic chips containing logic gates (e.g., Application Specific Integrated Circuits (ASIC), Field Programmable Gate Arrays (FPGA), System-On-Chip (SOC), etc.), a circuit utilizing a microprocessor, or on a single chip containing electronic elements or microprocessors. Furthermore, the elements of the operating environment 100 may also be practiced using other technologies capable of performing logical operations such as, for example, AND, OR, and NOT, including but not limited to, mechanical, optical, fluidic, and quantum technologies. As described in greater detail below with respect to FIGS. 6 and 7, the elements of the operating environment 100 may be practiced in a computing device 600 and/or communications device 700.

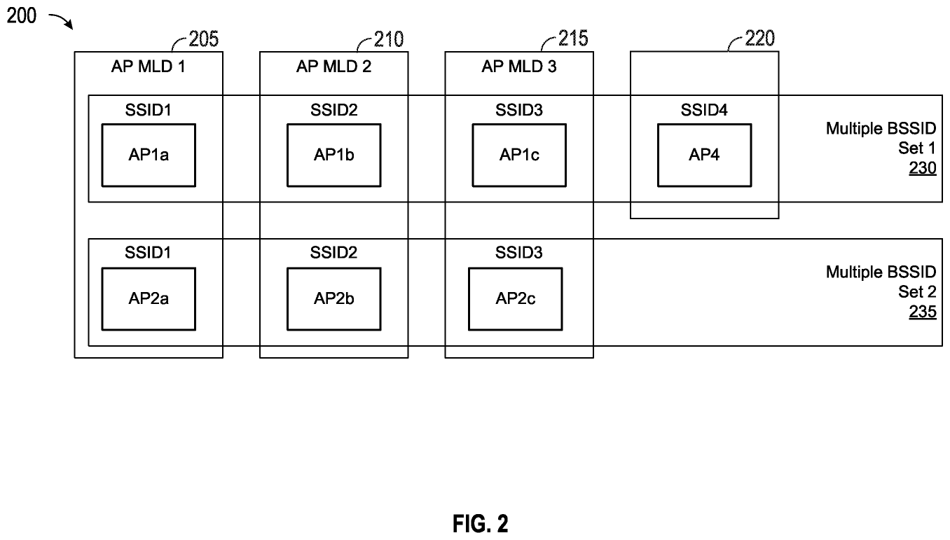

FIG. 2 illustrates an example physical AP device 200 (e.g., first AP 115, second AP 120, or third AP 125) comprising a plurality of APs organized into multiple BSSID sets. In the illustrated embodiment, AP device 200 includes a first AP Multi-Link Device (MLD) 205, a second AP MLD 210, a third AP MLD 215, and a fourth AP 220. AP1a of first AP MLD 205, AP1b of second AP MLD 210, AP1c of third AP MLD 215, and the fourth AP 220 (shown as AP4) are members of Multiple BSSID Set 1 230. AP2a of first AP MLD 205, AP2b of second AP MLD 210, and AP2c of third AP MLD 215 are members of Multiple BSSID Set 2 235. AP device 200 may include any number of APs (e.g., virtual APs) and multiple BSSID sets in further embodiments, including various combinations of non-MLD APs and AP MLDs organized into one or more multiple BSSID sets.

As shown in FIG. 2, Multiple BSSID Set 1 230 and Multiple BSSID Set 2 235 each contain APs operating on the same radio band. For example, APs of Multiple BSSID Set 1 230 may be operating on the same channel in 6 GHz band and APs of Multiple BSSID Set 2 235 may be operating on a different channel in the 6 GHz band. The two multiple BSSID sets may also be operating on channels on different bands (e.g. 6 GHz band and 5 GHz band). Within each set, one AP corresponds to the transmitted BSSID, such as AP1a for Multiple BSSID Set 1 230 and AP2a for Multiple BSSID Set 2 235, and transmits beacon and probe response frames on behalf of the entire set, while the remaining APs correspond to nontransmitted BSSIDs.

The APs corresponding to the transmitted BSSID, such as AP1a and AP2a, transmit beacon frames and other management frames (e.g., probe response frames) that include Multiple BSSID elements. In accordance with the present disclosure, these Multiple BSSID elements are configured to enable each BSSID in a multiple BSSID set to independently support different operating modes, operating mode parameters, capabilities, and/or PHY generations.

### Different Operating Modes and Operating Parameters Per BSSID in a Multiple BSSID Set

Per IEEE 802.11 baseline behavior, Operation and capabilities elements are always inherited from the transmitted BSSID to nontransmitted BSSIDs and are not carried within nontransmitted BSSID profile subelements. This mandates that all BSSIDs in a multiple BSSID set enable exactly the same set of operating modes and parameters and support same capabilities. For UHR and future Wi-Fi generations, several new operating modes are defined, such as NPCA, DBE, DSO, and P-EDCA, and it is desirable to enable different BSSIDs within the same multiple BSSID set to have different sets of these operating modes enabled and, where applicable, different operating parameters for those modes. Also, different BSSIDs may indicate support for different capabilities (e.g. support for different UHR modes) in the multiple BSSID set. For example, a P-EDCA mode may be supported and/or enabled for an employee SSID but not for a guest SSID which are part of the same multiple BSSID set, due to additional complexity or potential interference effects on legacy stations.

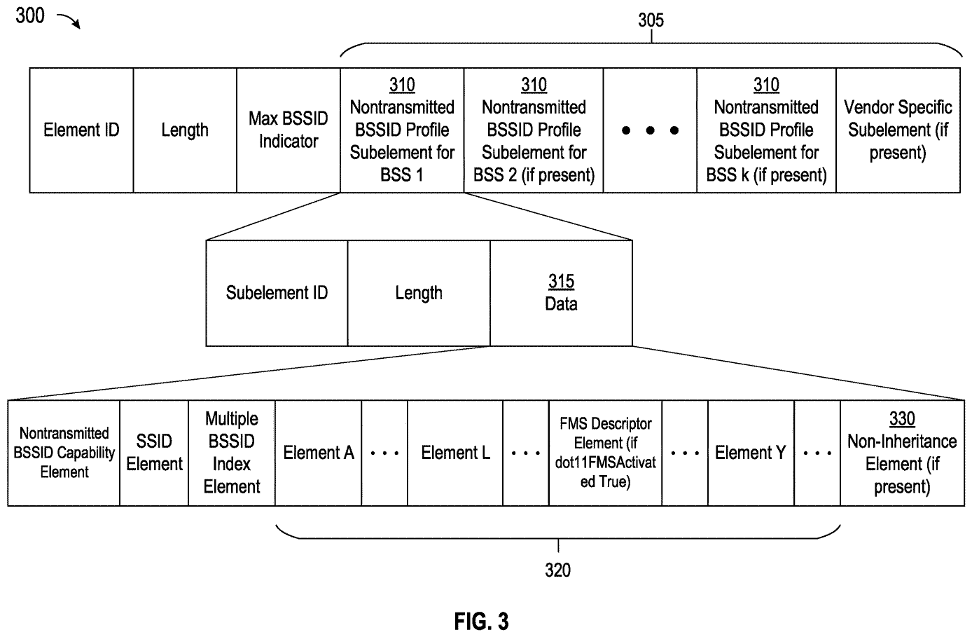

FIG. 3 illustrates an example Multiple BSSID element 300. The Multiple BSSID element 300 can be transmitted by the AP corresponding to the transmitted BSSID of a multiple BSSID set to indicate operating modes, operating mode parameters, and/or generational capabilities of the APs in the multiple BSSID set. For example, AP1a of the Multiple BSSID Set 1 230 and AP2a of the Multiple BSSID Set 2 235 include the Multiple BSSID element 300 in beacon frames, probe response frames, and other management frames.

The Multiple BSSID element 300 includes optional fields 305 including any number of Nontransmitted BSSID Profile subelements 310. Each Nontransmitted BSSID Profile subelement 310 carries information specific to one nontransmitted BSSID in the set. In the illustrated embodiment, each Nontransmitted BSSID Profile subelement 310 includes a data field 315 comprising a field section 320 and may also include a Non-Inheritance element 330. The field section 320 is positioned after a Nontransmitted BSSID Capability element, an SSID element, and a Multiple BSSID Index element and may include multiple elements ordered as defined in the relevant frame format.

Each Nontransmitted BSSID Profile subelement 310 may include its own UHR Operation element in the field section 320 to indicate the set of operating modes enabled for that nontransmitted BSSID. Each Nontransmitted BSSID Profile subelement 310 may also include its own UHR Capabilities element in the field section 320 to indicate the set of UHR capabilities supported for that nontransmitted BSSID. Where a UHR Operation element and/or a UHR Capabilities element is present in a nontransmitted BSSID profile, a client station uses those elements for the corresponding nontransmitted BSSID rather than inheriting the UHR Operation element and/or UHR Capabilities element from the transmitted BSSID. This rule applies to future generations of Wi-Fi as well such that each nontransmitted BSSID profile may include its own specific Operation and Capabilities elements for UHR and future Wi-Fi generations. (e.g., Wi-Fi 9, Wi-Fi 10). If no such elements are present in the nontransmitted BSSID profile, the client station inherits the Operation and Capabilities elements from the transmitted BSSID as in the baseline.

When the UHR Operation element also carries operating parameters for different operating modes, the nontransmitted BSSID may have different operating parameters for a specific operating mode compared to the transmitted BSSID. In that case, the UHR Operation element is included in the nontransmitted BSSID profile subelement 310 to provide the different operating parameters, even where the transmitted and nontransmitted BSSIDs have the same set of operating modes enabled. For example, a guest BSSID and an employee BSSID may both enable a P-EDCA mode, but the guest BSSID may carry more conservative parameters for that mode within its own UHR Operation element.

If the UHR Operation element does not provide detailed operating parameters, a separate element (e.g., a UHR Operating Parameters element) may carry those parameters. Such an element may likewise be included in a nontransmitted BSSID profile to provide operating parameters specific to that nontransmitted BSSID, independently of the corresponding element carried in the transmitted BSSID profile.

### Different PHY Generation Capabilities in a Multiple BSSID Set

Per IEEE 802.11 baseline behavior, all BSSIDs in a multiple BSSID set must support the same Wi-Fi or PHY generation and the same capabilities, as enforced by carrying Operation and Capabilities elements only for the transmitted BSSID profile, from which all nontransmitted BSSIDs unconditionally inherit. This creates operational inflexibility in the field. For example, when a network administrator wishes to upgrade an individual SSID to a new Wi-Fi generation (e.g., upgrading an employee SSID from Wi-Fi 7 to Wi-Fi 8 while leaving a guest SSID at Wi-Fi 7), the multiple BSSID grouping must change, causing disruption to client stations associated with other BSSIDs in the set.

To enable flexibility of upgrades between various PHY generations for APs on a physical AP device, a nontransmitted BSSID is permitted to carry different sets of Operation and Capabilities elements than the transmitted BSSID in a multiple BSSID set, enabling BSSIDs of different Wi-Fi generations to coexist within the same flexible multiple BSSID set while being compatible with pre-UHR client devices and interoperable. Because the transmitted BSSID transmits the beacon on behalf of all BSSIDs in the set and that beacon must carry information for all nontransmitted BSSIDs, in some embodiments the transmitted BSSID may be of the highest Wi-Fi or PHY generation in the set so that the beacon supports all necessary features, including UHR critical update features that introduce changes to the beacon format. In an alternative embodiment, the transmitted BSSID may be of a lower PHY generation than one or more nontransmitted BSSIDs, provided that no interoperability issues or loss of functionality result from such a configuration.

In a first case, the transmitted BSSID supports a higher Wi-Fi generation than a nontransmitted BSSID. For example, Multiple BSSID Set 1 230 and/or Multiple BSSID Set 2 235 are flexible multiple BSSID sets that are compatible with pre-UHR devices and enable flexible grouping of APs of different generations, with the AP corresponding to the transmitted BSSID in the highest generation in the multiple BSSID set. For example, AP1a may be a UHR AP (or Wi-Fi 9 AP if Wi-Fi 9 is supported) and therefore eligible for having the transmitted BSSID of the multiple BSSID set 1 230. By assigning the highest generation AP as the transmitted BSSID, the AP can support all features across generations. The AP corresponding to the transmitted BSSID (e.g., AP1a) can include capabilities and operation elements (e.g., UHR Capabilities and UHR Operation elements) in the beacon and probe response frames to indicate its operating modes, the operating mode parameters, and/or capabilities. For transmitted BSSID, the Capabilities and Operation elements are carried outside the multiple BSSID element in the beacon and probe response frames.

For an AP corresponding to a nontransmitted BSSID which is of a lower generation than the transmitted BSSID, the Non-Inheritance element 330 will list the Capability and Operation elements that are not inherited from the transmitted BSSID. For example, where the transmitted BSSID (of AP1a) supports Wi-Fi 8 (IEEE 802.11bn) and a nontransmitted BSSID (of AP1b) supports Wi-Fi 7 (IEEE 802.11be), the UHR Operation and UHR Capabilities elements are listed in the Non-Inheritance element 330 of that nontransmitted BSSID profile subelement 310 (For AP1b). Similarly, where the transmitted BSSID supports Wi-Fi 9 and a nontransmitted BSSID supports Wi-Fi 8, the Operation and Capabilities elements for Wi-Fi 9 are listed in that nontransmitted BSSID's Non-Inheritance element 330. If only an Operation element (and not a Capabilities element) is carried in the beacon of the transmitted BSSID, only the Operation element need be listed in the Non-Inheritance element 330 in the beacon frame. The probe response frame may carry both the Operation and Capabilities elements and then both will be listed in the Non-Inheritance element 330.

For UHR APs corresponding to nontransmitted BSSIDs, certain features can be enabled and disabled differently or support different operating mode parameters (where applicable) for each BSSID in a multiple BSSID set. Therefore, UHR Operation and UHR Capability elements can be included in the Nontransmitted BSSID profile subelements 310 for indicating capabilities support and operating mode enablement or disablement and the associated operating mode parameters of UHR APs. For example, AP1c is a UHR AP and its operating modes, the operating mode parameters, and/or capabilities are indicated in a Nontransmitted BSSID profile subelements 310 by including UHR Capabilities and/or UHR Operation elements.

In some embodiments, there are no interoperability issues or loss of functionality if the transmitted BSSID is a lower generation in future, such as when the multiple BSSID set includes Wi-Fi 8 and Wi-Fi 9 BSSIDs. In these embodiments, the transmitted BSSID can also be allowed to be a lower generation BSSID than a nontransmitted BSSID. For example, AP1a can be a UHR (Wi-Fi 8) AP, and AP1b can be a Wi-Fi 9 AP. In this case, the Operation and Capabilities elements for the higher generation are included directly in the nontransmitted BSSID profile subelement 310 for that nontransmitted BSSID, such as in the field section 320. For example, where the transmitted BSSID supports Wi-Fi 8 and a nontransmitted BSSID supports Wi-Fi 9, the nontransmitted BSSID profile includes the Operation and Capabilities elements for Wi-Fi 9 in the field section 320.

In some embodiments, the transmitted BSSID supports the same Wi-Fi generation as one or more nontransmitted BSSIDs, while one or more other nontransmitted BSSIDs in the same set support a different generation. For the nontransmitted BSSID that shares the same generation as the transmitted BSSID, no additional Operation or Capabilities elements for a higher generation are included in its nontransmitted BSSID profile subelement 310, nor are any elements listed in its Non-Inheritance element 330, when the nontransmitted BSSID has the same operating modes, the operating mode parameters, and capabilities. In this case, those elements are inherited from the transmitted BSSID as in the baseline. For example, where the transmitted BSSID supports Wi-Fi 8 (AP1a) and a first nontransmitted BSSID also supports Wi-Fi 8 (AP1b) with same operating modes, the operating mode parameters, and capabilities, the elements are inherited for the first nontransmitted BSSID (AP1b), while a second nontransmitted BSSID supporting Wi-Fi 9 (AP1c) would include the additional Wi-Fi 9 Operation and Capabilities elements in its nontransmitted BSSID profile subelement 310 (e.g., in the field section 320). In some embodiments, even though a nontransmitted BSSID has the same Wi-Fi generation as the transmitted BSSID, it may still support different operating modes, the operating mode parameters, and/or capabilities (as described above). In this case, the Operation and Capabilities elements will be carried in the corresponding nontransmitted BSSID profile.

WI-FI 6 BSSIDs may be excluded from a flexible MBSSID set due to interoperability issues for Wi-Fi 7 devices. For example, when a Wi-Fi 6 BSSID is a Nontransmitted BSSID in a Multiple BSSID set that includes Wi-Fi7/11be and/or Wi-Fi8/11bn BSSIDs, a Wi-Fi 7 STA that associates with a nontransmitted BSSID that is a Wi-Fi6 BSSID would see that EHT Capability and EHT Operation elements are listed in the Non-Inheritance element 330 (since these are not inherited for a Wi-Fi 6 BSSID). This is incompatible with the operation of a Wi-Fi 7 STA, since EHT Cap and Op are always inherited per its baseline rules. Therefore, Wi-Fi 6 APs are not allowed to mix with Wi-Fi 7 and/or Wi-Fi 8 APs in a flexible multiple BSSID set.

### Inheritance by Reference

As an extension to different generational capabilities operations described above, where at least two generational Operation, Capabilities, or Operating Parameters elements are expected to be large in size, a more efficient inheritance mechanism may be applied. If the content of such an element is identical to an element already carried in the transmitted BSSID profile or an earlier nontransmitted BSSID profile, it may be inherited by reference rather than repeated in full within the nontransmitted BSSID profile subelement 310.

For example, a reference field value of 0 implies inheritance from the transmitted BSSID profile; a reference field value of 1 implies inheritance from the first nontransmitted BSSID profile; a reference field value of 2 implies inheritance from the second nontransmitted BSSID profile; and so on. This reference information may be carried in an Inheritance-by-Reference subelement with a format comprising an element ID field, a length field, and N tuples each consisting of an element ID, an element ID extension, and a reference field.

Alternatively, since the elements subject to this mechanism are expected to be longer than one octet, the reference field may be carried as a variant of each element itself. In this alternative format, an element with already-transmitted content is represented by an element ID, a length field, an element ID extension, and a reference field in place of the full element payload. The unexpectedly short length value signals the presence of the reference field rather than the full element payload, allowing a receiving station to identify and process the inheritance-by-reference variant.

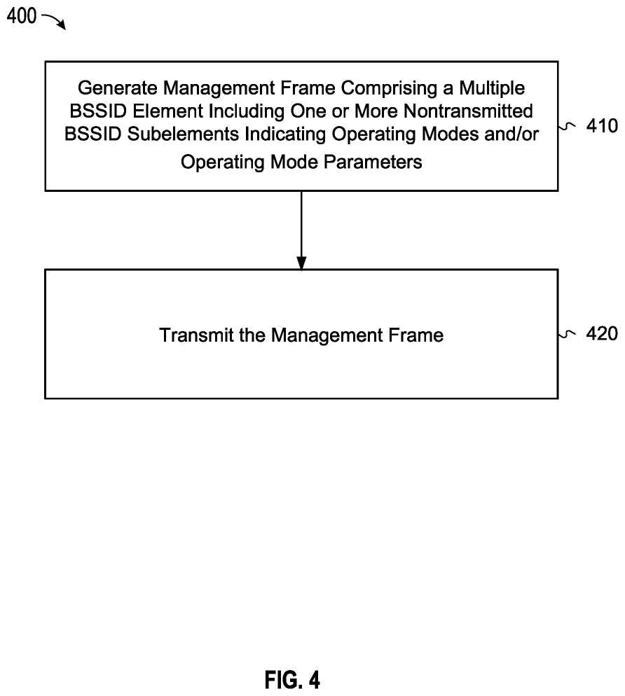

FIG. 4 illustrates an example method 400 performed by an AP corresponding to a transmitted BSSID of a multiple BSSID set. The multiple BSSID set comprises the transmitted BSSID and one or more nontransmitted BSSIDs. Method 400 may be performed by, for example, AP1a of Multiple BSSID Set 1 230 or AP2a of Multiple BSSID Set 2 235 of AP device 200.

At stage 410, the AP corresponding to the transmitted BSSID generates a management frame comprising a Multiple BSSID element. The Multiple BSSID element comprises one or more nontransmitted BSSID profile subelements each corresponding to a respective nontransmitted BSSID of the multiple BSSID set. At least one nontransmitted BSSID profile subelement of the one or more nontransmitted BSSID profile subelements comprises an operation element indicating at least one of: (i) one or more operating modes enabled for the corresponding nontransmitted BSSID, or (ii) one or more operating mode parameters for the corresponding nontransmitted BSSID. In this manner, each nontransmitted BSSID profile subelement may independently indicate the operating modes enabled and operating parameters applicable to the corresponding nontransmitted BSSID, rather than unconditionally inheriting the operation element of the transmitted BSSID as mandated by IEEE 802.11 baseline behavior. The management frame may be a beacon frame, a probe response frame, or any other suitable management frame.

At stage 420, the AP corresponding to the transmitted BSSID transmits the management frame. The transmitted management frame includes the Multiple BSSID element with one or more nontransmitted BSSID profile subelements configured as described above, enabling each nontransmitted BSSID in the flexible MBSSID set to independently support different operating modes, operating parameters, capabilities, and/or PHY generations relative to the transmitted BSSID and relative to other nontransmitted BSSIDs in the set. A device that receives the management frame uses the operation element included in a nontransmitted BSSID profile subelement for the corresponding nontransmitted BSSID, rather than inheriting the operation element from the transmitted BSSID, when such an element is present in that subelement.

In some embodiments, the at least one nontransmitted BSSID profile subelement further comprises an operating parameters element indicating operating mode parameters of the corresponding nontransmitted BSSID. The operating parameters element is a separate element from the operation element and may be included in the nontransmitted BSSID profile subelement where the operation element does not itself carry detailed operating parameters for the corresponding operating modes.

In some embodiments, the at least one nontransmitted BSSID profile subelement further comprises a capabilities element indicating one or more capabilities of the corresponding nontransmitted BSSID. The capabilities element may be included in the nontransmitted BSSID profile subelement where the capabilities of the corresponding nontransmitted BSSID differ from the capabilities of the transmitted BSSID.

In some embodiments, the nontransmitted BSSID corresponding to the at least one nontransmitted BSSID profile subelement may be of the same Wi-Fi generation as the transmitted BSSID in the multiple BSSID set. Further, the at least one of the operation element or the capabilities element in the nontransmitted BSSID corresponding to the at least one nontransmitted BSSID profile subelement may be different than the corresponding operation and capabilities elements of the transmitted BSSID, to indicate different operating modes, operating parameters and capabilities for the nontransmitted BSSID.

In certain embodiments, the multiple BSSID set supports a plurality of Wi-Fi generations, and the transmitted BSSID supports the highest Wi-Fi generation among all BSSIDs in the multiple BSSID set. Because the transmitted BSSID transmits beacon frames on behalf of the entire multiple BSSID set, assigning the highest-generation AP the transmitted BSSID ensures that the beacon supports all features and frame format changes defined for that generation, including UHR critical update features, without loss of functionality for any nontransmitted BSSID in the set.

In some embodiments in which the multiple BSSID set supports a plurality of Wi-Fi generations, the corresponding nontransmitted BSSID supports a Wi-Fi generation lower than the highest Wi-Fi generation among all BSSIDs in the multiple BSSID set, and the operation element is carried in a Non-Inheritance element of the at least one nontransmitted BSSID profile subelement. Listing the operation element in the Non-Inheritance element signals to a receiving station that the operation element of the transmitted BSSID is not inherited for the corresponding nontransmitted BSSID. In a beacon frame that does not carry Capabilities elements associated with the higher generation, only the operation element associated with the higher generation is listed in the Non-Inheritance element. In a probe response frame that carries both Operation and Capabilities elements associated with the higher generation, both the operation element and the capabilities element are listed in the Non-Inheritance element.

In certain embodiments, the transmitted BSSID supports a first Wi-Fi generation and a first nontransmitted BSSID corresponding to a first nontransmitted BSSID profile subelement of the one or more nontransmitted BSSID profile subelements supports a second Wi-Fi generation higher than the first Wi-Fi generation. In this case, the first nontransmitted BSSID profile subelement comprises at least one of: (i) one or more operation elements associated with the second Wi-Fi generation, or (ii) one or more capabilities elements associated with the second Wi-Fi generation. These elements are included directly in the first nontransmitted BSSID profile subelement rather than being inherited from the transmitted BSSID, which may not carry elements for the higher generation.

In some embodiments, a nontransmitted BSSID profile subelement of the one or more nontransmitted BSSID profile subelements corresponds to a nontransmitted BSSID supporting a same Wi-Fi generation as the transmitted BSSID. In this case, either: (i) for the nontransmitted BSSID to inherit operating modes and capabilities from the transmitted BSSID, the nontransmitted BSSID profile subelement does not comprise a capabilities element indicating capabilities or the operation element, such that the operation element and capabilities element of the transmitted BSSID are inherited as in the baseline; or (ii) for the nontransmitted BSSID to have at least one of different operating modes or different capabilities from the transmitted BSSID, the nontransmitted BSSID profile subelement comprises at least one of the capabilities element or the operation element to indicate the differing modes or capabilities specific to that nontransmitted BSSID.

In some embodiments, a nontransmitted BSSID profile subelement of the one or more nontransmitted BSSID profile subelements comprises an Inheritance-by-Reference subelement indicating that at least one of an operation element, a capabilities element, or an operating parameters element is to be inherited by reference from a previously identified profile. A reference field value of zero in the Inheritance-by-Reference subelement indicates inheritance from the transmitted BSSID profile. A reference field value of N indicates inheritance from the Nth nontransmitted BSSID profile subelement of the multiple BSSID set. The Inheritance-by-Reference subelement may comprise a format including an element ID field, a length field, and one or more tuples each comprising an element identifier, an element ID extension, and a reference field. In an alternative format, an element subject to this mechanism may be represented by an element ID, a length field, an element ID extension, and a reference field in place of the full element payload, where the unexpectedly short length value signals the presence of the reference field to a receiving station.

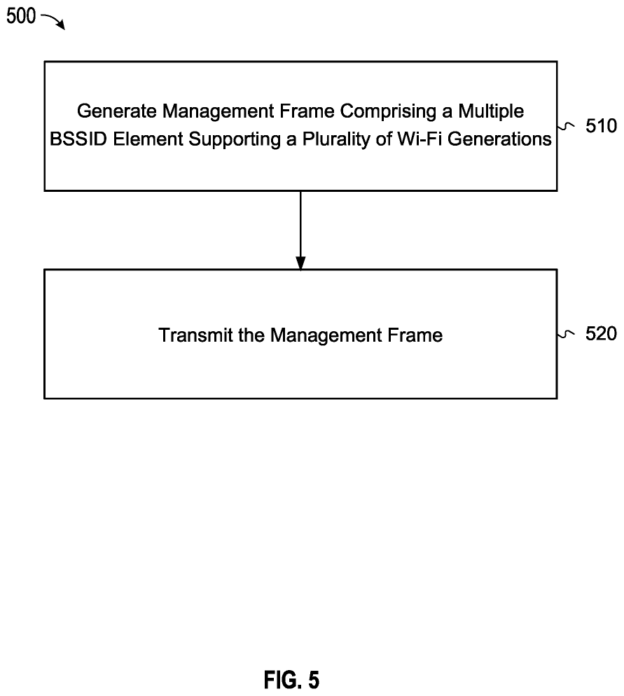

FIG. 5 illustrates an example method 500 performed by an AP corresponding to a transmitted BSSID of a multiple BSSID set. The multiple BSSID set comprises the transmitted BSSID and one or more nontransmitted BSSIDs. Method 500 may be performed by, for example, AP1a of Multiple BSSID Set 1 230 or AP2a of Multiple BSSID Set 2 235 of AP device 200.

At stage 510, the AP corresponding to the transmitted BSSID generates a management frame comprising a Multiple BSSID element. The Multiple BSSID set supports a plurality of Wi-Fi generations across the transmitted BSSID and nontransmitted BSSIDs of the multiple BSSID set.

At stage 520, the AP corresponding to the transmitted BSSID transmits the management frame. The transmitted management frame includes the Multiple BSSID element with one or more nontransmitted BSSID profile subelements configured as described above, enabling each nontransmitted BSSID in the flexible MBSSID set to independently support different operating modes, operating parameters, capabilities, and/or PHY generations relative to the transmitted BSSID and relative to other nontransmitted BSSIDs in the set. A device that receives the management frame uses the operation element included in a nontransmitted BSSID profile subelement for the corresponding nontransmitted BSSID, rather than inheriting the operation element from the transmitted BSSID, when such an element is present in that subelement.

In some embodiments, the transmitted BSSID supports a highest Wi-Fi generation among all BSSIDs in the multiple BSSID set. In certain embodiments, a nontransmitted BSSID corresponding to a nontransmitted BSSID profile subelement of the one or more nontransmitted BSSID profile subelements supports a Wi-Fi generation lower than the Wi-Fi generation of the transmitted BSSID in the multiple BSSID set, wherein at least one of an operation element or a capabilities element associated with the Wi-Fi generation of the transmitted BSSID is included in a non-inheritance element in the corresponding nontransmitted BSSID profile subelement.

In some embodiments, the transmitted BSSID supports a first Wi-Fi generation and a first nontransmitted BSSID corresponding to a first nontransmitted BSSID profile subelement of the one or more nontransmitted BSSID profile subelements supports a second Wi-Fi generation higher than the first Wi-Fi generation, wherein the first nontransmitted BSSID profile subelement comprises at least one of: (i) one or more operation elements associated with the second Wi-Fi generation or (ii) one or more capabilities elements associated with the second Wi-Fi generation.

In some embodiments, a nontransmitted BSSID profile subelement of the one or more nontransmitted BSSID profile subelements corresponds to a nontransmitted BSSID supporting a same Wi-Fi generation as the transmitted BSSID. For the nontransmitted BSSID to inherit operating modes and capabilities from the transmitted BSSID, the nontransmitted BSSID profile subelement does not comprise a capability element indicating capabilities or an operation element. For the nontransmitted BSSID to have at least one of different operating modes or different capabilities from the transmitted BSSID, the nontransmitted BSSID profile subelement comprises at least one of the capability element or the operation element.

In some embodiments, at least one nontransmitted BSSID profile subelement of the one or more nontransmitted BSSID profile subelements comprises an operation element indicating at least one of: (i) one or more operating modes enabled for a corresponding nontransmitted BSSID, or (ii) one or more operating mode parameters for the corresponding nontransmitted BSSID.

FIG. 6 is a block diagram of a computing device 600. As shown in FIG. 6, computing device 600 may include a processing unit 610 and a memory unit 616. Memory unit 616 may include a software module 620 and a database 626. While executing on processing unit 610, software module 620 may perform, for example, processes for providing different operating mode, parameters, and capabilities support in a multiple BSSID set. Computing device 600, for example, may provide an operating environment for the controller 105, the first AP 115, the second AP 120, the third AP 125, the first client device 130, the second client device 135, the third client device 140, and the like. controller 105, the first AP 115, the second AP 120, the third AP 125, the first client device 130, the second client device 135, the third client device 140, and the like may operate in other environments and are not limited to computing device 600.

Computing device 600 may be implemented using a Wi-Fi access point, a tablet device, a mobile device, a smart phone, a telephone, a remote control device, a set-top box, a digital video recorder, a cable modem, a personal computer, a network computer, a mainframe, a router, a switch, a server cluster, a smart TV-like device, a network storage device, a network relay device, or other similar microcomputer-based device. Computing device 600 may comprise any computer operating environment, such as hand-held devices, multiprocessor systems, microprocessor-based or programmable sender electronic devices, minicomputers, mainframe computers, and the like. Computing device 600 may also be practiced in distributed computing environments where tasks are performed by remote processing devices. The aforementioned systems and devices are examples, and computing device 600 may comprise other systems or devices.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

While certain embodiments of the disclosure have been described, other embodiments may exist. Furthermore, although embodiments of the present disclosure have been described as being associated with data stored in memory and other storage mediums, data can also be stored on, or read from, other types of computer-readable media, such as secondary storage devices, like hard disks, floppy disks, or a CD-ROM, a carrier wave from the Internet, or other forms of RAM or ROM. Further, the disclosed methods' stages may be modified in any manner, including by reordering stages and/or inserting or deleting stages, without departing from the disclosure.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to, mechanical, optical, fluidic, and quantum technologies. In addition, embodiments of the disclosure may be practiced within a general purpose computer or in any other circuits or systems.

Embodiments of the disclosure may be practiced via a SOC where each or many of the elements illustrated in FIG. 1 may be integrated onto a single integrated circuit. Such an SOC device may include one or more processing units, graphics units, communications units, system virtualization units and various application functionality all of which may be integrated (or “burned”) onto the chip substrate as a single integrated circuit. When operating via an SOC, the functionality described herein with respect to embodiments of the disclosure may be performed via application-specific logic integrated with other components of computing device 600 on the single integrated circuit (chip).

FIG. 7 illustrates an implementation of a communications device 700 that may implement one or more of the controller 105, the first AP 115, the second AP 120, the third AP 125, the first client device 130, the second client device 135, the third client device 140, etc. In various implementations, the communications device 700 may comprise a logic circuit. The logic circuit may include physical circuits to perform operations described for one or more of the controller 105, the first AP 115, the second AP 120, the third AP 125, the first client device 130, the second client device 135, the third client device 140, etc., for example. As shown in FIG. 7, the communications device 700 may include one or more of, but is not limited to, a radio interface 710, baseband circuitry 730, and/or the computing device 600.

The communications device 700 may implement some or all of the structures and/or operations for the controller 105, the first AP 115, the second AP 120, the third AP 125, the first client device 130, the second client device 135, the third client device 140, etc., storage medium, and logic circuit in a single computing entity, such as entirely within a single device. Alternatively, the communications device 700 may distribute portions of the structure and/or operations using a distributed system architecture, such as a client station server architecture, a peer-to-peer architecture, a master-slave architecture, etc.

A radio interface 710, which may also include an Analog Front End (AFE), may include a component or combination of components adapted for transmitting and/or receiving single-carrier or multi-carrier modulated signals (e.g., including Complementary Code Keying (CCK), Orthogonal Frequency Division Multiplexing (OFDM), and/or Single-Carrier Frequency Division Multiple Access (SC-FDMA) symbols), although the configurations are not limited to any specific interface or modulation scheme. The radio interface 710 may include, for example, a receiver 715 and/or a transmitter 720. The radio interface 710 may include bias controls, a crystal oscillator, and/or one or more antennas 725. In additional or alternative configurations, the radio interface 710 may use oscillators and/or one or more filters, as desired.

The baseband circuitry 730 may communicate with the radio interface 710 to process, receive, and/or transmit signals and may include, for example, an Analog-To-Digital Converter (ADC) for down converting received signals with a Digital-To-Analog Converter (DAC) 735 for up converting signals for transmission. Further, the baseband circuitry 730 may include a baseband or PHY layer processing circuit for the PHY link layer processing of respective receive/transmit signals. Baseband circuitry 730 may include, for example, a MAC processing circuit 740 for MAC/data link layer processing. Baseband circuitry 730 may include a memory controller for communicating with MAC processing circuit 740 and/or a computing device 600, for example, via one or more interfaces 745.

In some configurations, PHY processing circuit may include a frame construction and/or detection module, in combination with additional circuitry such as a buffer memory, to construct and/or deconstruct communication frames. Alternatively or in addition, MAC processing circuit 740 may share processing for certain of these functions or perform these processes independent of PHY processing circuit. In some configurations, MAC and PHY processing may be integrated into a single circuit.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While the specification includes examples, the disclosure's scope is indicated by the following claims. Furthermore, while the specification has been described in language specific to structural features and/or methodological acts, the claims are not limited to the features or acts described above. Rather, the specific features and acts described above are disclosed as examples for embodiments of the disclosure.

1. A method comprising:
generating, by an access point (AP) corresponding to a transmitted basic service set identifier (BSSID) of a multiple BSSID set, a management frame comprising a multiple BSSID element, the multiple BSSID element comprising one or more nontransmitted BSSID profile subelements each corresponding to a respective nontransmitted BSSID of the multiple BSSID set, wherein at least one nontransmitted BSSID profile subelement of the one or more nontransmitted BSSID profile subelements comprises an operation element indicating at least one of: (i) one or more operating modes enabled for a corresponding nontransmitted BSSID, or (ii) one or more operating mode parameters for the corresponding nontransmitted BSSID; and
transmitting, by the AP corresponding to the transmitted BSSID, the management frame.

2. The method of claim 1, wherein the at least one nontransmitted BSSID profile subelement further comprises an operating parameters element indicating operating mode parameters of the corresponding nontransmitted BSSID.

3. The method of claim 1, wherein the at least one nontransmitted BSSID profile subelement further comprises a capabilities element indicating one or more capabilities of the corresponding nontransmitted BSSID.

4. The method of claim 1, wherein:
the multiple BSSID set supports a plurality of Wi-Fi generations; and
the transmitted BSSID supports a highest Wi-Fi generation among all BSSIDs in the multiple BSSID set.

5. The method of claim 4, wherein:
the corresponding nontransmitted BSSID supports a Wi-Fi generation lower than the highest Wi-Fi generation among all BSSIDs in the multiple BSSID set; and
the operation element is in a non-inheritance element.

6. The method of claim 1, wherein the transmitted BSSID supports a first Wi-Fi generation and a first nontransmitted BSSID corresponding to a first nontransmitted BSSID profile subelement of the one or more nontransmitted BSSID profile subelements supports a second Wi-Fi generation higher than the first Wi-Fi generation, wherein the first nontransmitted BSSID profile subelement comprises at least one of: (i) one or more operation elements associated with the second Wi-Fi generation or (ii) one or more capabilities elements associated with the second Wi-Fi generation.

7. The method of claim 1, wherein:
a nontransmitted BSSID profile subelement of the one or more nontransmitted BSSID profile subelements corresponds to a nontransmitted BSSID supporting a same Wi-Fi generation as the transmitted BSSID; and
for the nontransmitted BSSID to have at least one of different operating modes or different capabilities from the transmitted BSSID, the nontransmitted BSSID profile subelement comprises at least one of the capability element or the operation element.

8. The method of claim 1, wherein:
a nontransmitted BSSID profile subelement of the one or more nontransmitted BSSID profile subelements comprises an Inheritance-by-reference subelement indicating that at least one of an operation element, a capabilities element, or an operating parameters element is to be inherited by reference from a previously identified profile.

9. A system comprising:
a memory storage; and
a processing unit coupled to the memory storage, wherein the processing unit is operative to:
operate as an access point (AP) corresponding to a transmitted basic service set identifier (BSSID) of a multiple BSSID set;
generate a management frame comprising a multiple BSSID element, the multiple BSSID element comprising one or more nontransmitted BSSID profile subelements each corresponding to a respective nontransmitted BSSID of the multiple BSSID set, wherein at least one nontransmitted BSSID profile subelement of the one or more nontransmitted BSSID profile subelements comprises an operation element indicating at least one of: (i) one or more operating modes enabled for a corresponding nontransmitted BSSID, or (ii) one or more operating mode parameters for the corresponding nontransmitted BSSID; and
transmit the management frame.

10. The system of claim 9, wherein the at least one nontransmitted BSSID profile subelement further comprises an operating parameters element indicating operating mode parameters of the corresponding nontransmitted BSSID.

11. The system of claim 9, wherein the at least one nontransmitted BSSID profile subelement further comprises a capabilities element indicating one or more capabilities of the corresponding nontransmitted BSSID.

12. The system of claim 9, wherein:
the multiple BSSID set supports a plurality of Wi-Fi generations; and
the transmitted BSSID supports a highest Wi-Fi generation among all BSSIDs in the multiple BSSID set.

13. The system of claim 12, wherein:
the corresponding nontransmitted BSSID supports a Wi-Fi generation lower than the highest Wi-Fi generation among all BSSIDs in the multiple BSSID set; and
the operation element is in a non-inheritance element.

14. The system of claim 9, wherein the transmitted BSSID supports a first Wi-Fi generation and a first nontransmitted BSSID corresponding to a first nontransmitted BSSID profile subelement of the one or more nontransmitted BSSID profile subelements supports a second Wi-Fi generation higher than the first Wi-Fi generation, wherein the first nontransmitted BSSID profile subelement comprises at least one of: (i) one or more operation elements associated with the second Wi-Fi generation or (ii) one or more capabilities elements associated with the second Wi-Fi generation.

15. A method comprising:
generating, by an access point (AP) corresponding to a transmitted basic service set identifier (BSSID) of a multiple BSSID set, a management frame comprising a multiple BSSID element, the multiple BSSID element comprising one or more nontransmitted BSSID profile subelements each corresponding to a respective nontransmitted BSSID of the multiple BSSID set, wherein the multiple BSSID set supports a plurality of Wi-Fi generations across the transmitted BSSID and nontransmitted BSSIDs of the multiple BSSID set; and
transmitting, by the AP corresponding to the transmitted BSSID, the management frame.

16. The method of claim 15, wherein the transmitted BSSID supports a highest Wi-Fi generation among all BSSIDs in the multiple BSSID set.

17. The method of claim 15, wherein:
a nontransmitted BSSID corresponding to a nontransmitted BSSID profile subelement of the one or more nontransmitted BSSID profile subelements supports a Wi-Fi generation lower than the Wi-Fi generation of the transmitted BSSID in the multiple BSSID set, wherein at least one of an operation element or a capabilities element associated with the Wi-Fi generation of the transmitted BSSID is included in a non-inheritance element in the corresponding nontransmitted BSSID profile subelement.

18. The method of claim 15, wherein the transmitted BSSID supports a first Wi-Fi generation and a first nontransmitted BSSID corresponding to a first nontransmitted BSSID profile subelement of the one or more nontransmitted BSSID profile subelements supports a second Wi-Fi generation higher than the first Wi-Fi generation, wherein the first nontransmitted BSSID profile subelement comprises at least one of: (i) one or more operation elements associated with the second Wi-Fi generation or (ii) one or more capabilities elements associated with the second Wi-Fi generation.

19. The method of claim 15, wherein:
a nontransmitted BSSID profile subelement of the one or more nontransmitted BSSID profile subelements corresponds to a nontransmitted BSSID supporting a same Wi-Fi generation as the transmitted BSSID; and
for the nontransmitted BSSID to have at least one of different operating modes or different capabilities from the transmitted BSSID, the nontransmitted BSSID profile subelement comprises at least one of the capability element or the operation element.

20. The method of claim 15, wherein at least one nontransmitted BSSID profile subelement of the one or more nontransmitted BSSID profile subelements comprises any one of:
an operation element indicating at least one of: (i) one or more operating modes enabled for a corresponding nontransmitted BSSID, or (ii) one or more operating mode parameters for the corresponding nontransmitted BSSID;
a capabilities element indicating one or more capabilities of the corresponding nontransmitted BSSID; or
both the operation element and the capabilities element.
